(19) United States
(12) Patent Application Publication
(10) Pub. No.: US 2007/0235575 A1
(43) Pub. Date: Oct. 11, 2007

(54) Roll mill

(76) Inventors: Heinz Resch, Flawil (CH); Walter Almer, Oberuzwil (CH)

Correspondence Address: Klaus P. Stoffel;Wolff & Samson, One Boland Drive, West Orange, NJ, 07052, US

(21) Appl. No.: 11/789,848

(22) Filed: Apr. 26, 2007

Related U.S. Application Data
(63) Continuation of application No. PCT/CH05/00539, filed on Sep. 12, 2005.

(30) Foreign Application Priority Data
Oct. 26, 2004 (DE) 102004052084.4

(51) Int. Cl. B02C 4/02

(52) U.S. Cl. 241/235

(57) ABSTRACT

A roll mill for comminuting and homogenizing viscous masses, in particular for dispersing and uniformly distributing solid particles suspended in a binding agent. The roll mill has at least two rolls pivoted around their longitudinal axes, wherein the rotational axis of the first roll is fixed in place, and the rotational axis of a second roll is movably mounted, as well as at least one pressing device for pressing at least one roll against the other roll. Roll pressing takes place by way of the pressing device. A first plane defined by the rotational axis of the front roll or feeder roll and by the rotational axis of the middle roll, and a second plane defined by the rotational axis of the middle roll and the rotational axis of the back roll or transfer roll, are inclined relative to each other by an angle of between 10° and 90°. The roll surfaces or process surfaces are made out of a metal-free ceramic material.

This application is a continuation of International Application No. PCT/CH2005/000539, filed Sep. 12, 2005, which claims priority from German application 10 2004 052 084.4 filed Oct. 26, 2004, the entire disclosures of which are incorporated herein by reference.

### BACKGROUND OF THE INVENTION

The invention relates to a roll mill, in particular to a three-roll mill, for comminuting and homogenizing viscous masses, in particular for dispersing and uniformly distributing solid particles suspended in a binding agent.

Such a roll mill has at least two rolls pivoted around their longitudinal axes, wherein the rotational axis of the first roll is fixed in place, and the rotational axis of a second roll is movably mounted. At least one roll is pressed against the other by means of at least one pressing device. The roll mill has a first plane, which is defined by the rotational axis of the front roll or feeder roll and by the rotational axis of the middle roll, and a second plane, which is defined by the rotational axis of the middle roll and by the rotational axis of the back roll or transfer roll, both of which are inclined relative to each other by an angle of between about 10° and a maximum 90°.

### SUMMARY OF THE INVENTION

The object of the invention is to provide a roll mill of the basic design mentioned at the outset that enables improved product quality on the one hand, while avoiding product inhomogeneities and inadequate cooling through better milling operation on the other.

According to the invention, the roll surfaces of the rolls or processing surfaces of the rolls are made out of a metal-free ceramic material, wherein the rolls preferably have a ceramic cylinder fit onto a hollow metal cylinder. This prevents the product from becoming metallically contaminated by roll abrasion in the comminuting process. This is particularly important while processing pastes for applications in electronics, and for the manufacture of insulating bodies based on fine ceramics.

In a particularly advantageous embodiment of this invention, the roll mill according to the invention is a so-called “three-roll mill” with three parallel rolls. The rotational axis of the middle roll is here fixed in place, while the rotational axis of the front roll or feeder roll and the rotational axis of the back roll or transfer roll are movable. To this end, it has a front mechanical-pneumatic pressing device for pressing the front roll against the middle roll, as well as a rear mechanical-pneumatic pressing device for pressing the back roll against the middle roll. This provides for two roll nips. In this way, the operating conditions for both roll nips can be independently adjusted by setting the nip distance, the differential velocity and the pressure in the respective nip.

The back roll or transfer roll intended for product removal can have a shorter axial process length than the middle roll, and can be axially situated relative to the middle roll in such a way that the ends of the process length of the middle roll extend bilaterally over the ends of the process length of the back roll or transfer roll. The advantage to this is that unabraded or only inadequately abraded product, i.e., excessively coarse product, does not pass from the middle roll to the back roll or transfer roll during roll mill operation. Therefore, this measure makes it possible to achieve an improved product quality, i.e., a more uniform product fineness, while avoiding undefined edge effects.

The first plane preferably runs horizontally, while the second plane runs upwardly inclined (L-shaped roll arrangement viewed from the side). The angle preferably measures 30° to 60°, with approx. 45° being especially preferred. As a result, the product present as a viscous mass with the solid particles (e.g., pigments) distributed therein is cooled for a longer period of time while passing through the roll mill than in an arrangement in which the rotational axes of the front, middle and back roll lie in a single plane.

Such an arrangement results in a greater retention time of the product on the cool surface of the rolls.

The rolls are best cooled from the inside. For example, this is important while processing organic pigments, in particular with respect to certain yellow pigments.

Both the front roll and the back roll are pressed against the middle roll by means of a mechanical-pneumatic pressing device. This makes it possible to adjust the front and back roll nip. The mechanical-pneumatic pressing device preferably has a control means for setting the nip. Since the force transducer, as explained above, enables a “force transmission” and “path reduction”, the relatively weak force of a pneumatic device can be multiplied for purposes of roll pressing, while at the same time greatly increasing the accuracy of nip adjustment prescribed by the pneumatic device.

The transfer roll is best abutted by a stripper that strips away the comminuted, homogenized mass, wherein the stripper also preferably consists of a metal-free material, in particular of a ceramic material or polymer material. This also prevents the product from becoming metallically contaminated in any way as the result of stripper abrasion while being stripped from the transfer roll.

A tarpaulin preferably covers at least the feed area of the roll mill. This prevents undesired contaminants from the factory building from getting into the product and vice versa, i.e., undesired volatile product constituents form getting into the air of the factory building. This improves “product hygiene” on the one hand, and “workplace hygiene” on the other.

The space under the tarpaulin is preferably connected with a gas vent. This makes it possible to keep volatile substances contained in the product solvent from getting into the air of a factory building.

### BRIEF DESCRIPTION OF THE DRAWINGS

Additional advantages, features and possible applications of the invention may be gleaned from the following description, wherein:

FIG. 1 shows a diagrammatic side view of a roll mill that does not conform to the invention;

FIG. 2 shows a top view of the rolls of the roll mill on FIG. 1;

FIG. 3 shows a diagrammatic side view of a roll mill according to the invention corresponding to FIG. 1, and

FIG. 4 shows a top view of the rolls of the roll mill on FIG. 3.

### DETAILED DESCRIPTION OF THE INVENTION

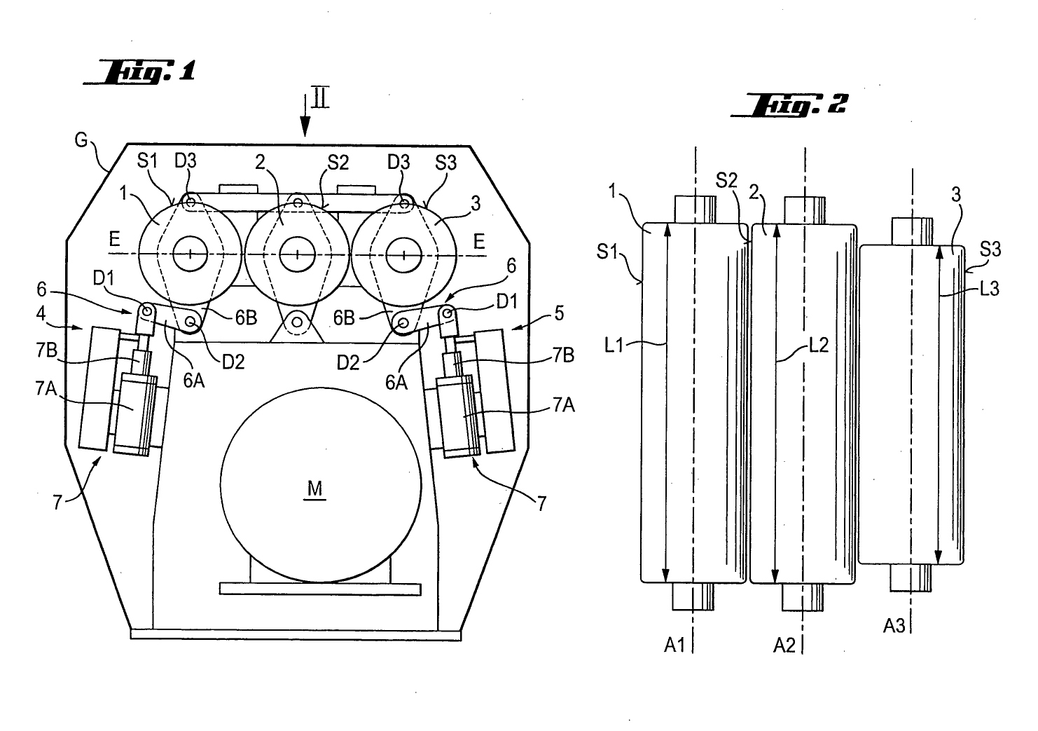

FIG. 1 and FIG. 2 show a roll mill that does not conform to the invention. The three-roll mill shown here contains three rolls 1, 2, 3, which are aligned parallel to each other, and all arranged in a single plane E. In other words, the rotational axis A1 of the front roll 1, the rotational axis A2 of the middle roll 2, and the rotational axis A3 of the back roll 3 are parallel to each other (see FIG. 2), and all lie in one and the same plane E. In the operating mode, the front roll 1 and the back roll 3 are each pressed by a front pressing device 4 or a back pressing device 5 against the middle roll 2, the rotational axis A2 of which is fixed in place. The front roll 1 and back roll 3 are movable, i.e., their rotational axes A1 and A3 can be pivoted around a swiveling axis D3. The jacket surfaces of rolls 1, 2, 3 each comprise the roll processing surface S1, S2, S3, with which the product to be processed comes into contact. During operation, the product passing between the rolls 1 and 2 pressed against each other creates a roll nip between the processing surface S1 of the front roll 1 and the processing surface S2 of the middle roll 2. In like manner, the product passing between the rollers 2 and 3 pressed against each other creates a roll nip during operation between the processing surface S3 of the back roll 3 and the processing surface S2 of the middle roll.

The front pressing device 4 and back pressing device 5 each have a force transducer 6 and a pneumatic drive 7. In the exemplary embodiment that does not conform to the invention shown on FIG. 1, the force transducer is a toggle mechanism 6, which consists of a first lever 6A and a second lever 6B, while the pneumatic drive 7 consists of a pneumatic cylinder 7A and a pneumatic piston. The force exerted by the pressing devices 4 and 5 flows from the pneumatic piston 7B, which is accommodated in the pneumatic cylinder 7A, and linked with the first lever 6A on an articulated axis D1 by means of a piston rod 7B. The first lever 6A is hinged to a second articulated axis D2 on the second lever 6B, which in turn is hinged to a pivoting axis D3, and forms a respective suspension and mounting arrangement for the front roll 1 and back roll 3.

Depending on how the levers 6A and 6B are dimensioned and oriented, the toggle mechanism 6A, 6B used as the force transducer 6 and roll suspension unit increase the pneumatic force of the pneumatic drive 7 by a factor of about 20 to 50, wherein this increased force is used for purposes of roll pressing. This enables a sufficiently strong roll pressing, even with a pneumatic drive 7. On the other hand, this force transducer 6 decreases the stroke traversed by the pneumatic drive 7 by a factor of about 1/50 to 1/20, wherein this reduced stroke is used to set the nip.

Rolls 1, 2 and 3 are driven by overdrives or gearboxes by engine M. The roll block 1, 2, 3 and engine block M are enveloped by a casing G.

FIG. 2 shows a top view of the rolls 1, 2, 3 of the roll mill that does not conform to the invention shown on FIG. 1. As evident, the front roll or feeder roll 1 and the middle roll 2 both have the same processing length L1=L2, while the back roll or transfer roll 3 has a distinctly shorter processing length L3<L2 to avoid undefined edge effects. The back roll 3 is axially arranged relative to the middle roll 2 in such a way that the ends of the processing length L2 of the middle roll 2 extend axially over the ends of the process length L3 of the back roll 3 on both sides. This ensures that unabraded or only inadequately abraded product does not pass from the middle roll 2 to the back roll 3 during roll mill operation, making it possible to achieve a distinctly improved product quality.

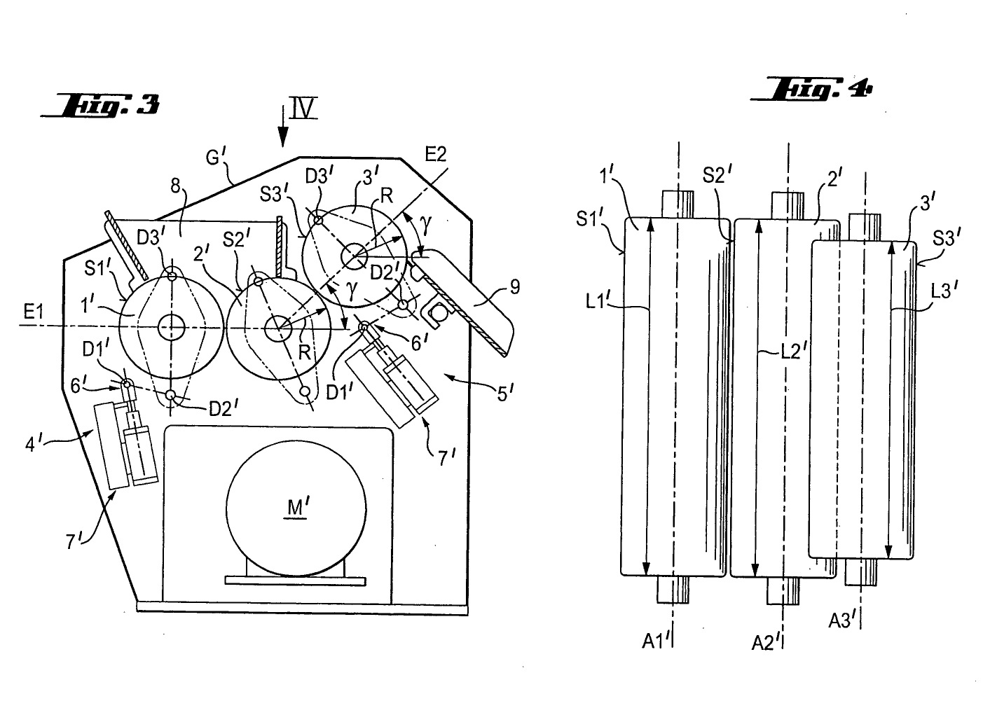

FIG. 3 and FIG. 4 show an exemplary embodiment of the roll mill according to the invention.

All elements of the second exemplary embodiment shown on FIG. 3 and FIG. 4 that are identical to the elements shown on FIG. 1 and FIG. 2 or correspond thereto bear the reference numbers of the corresponding element from FIG. 1 or FIG. 2 with a quote mark added. How these elements of the exemplary embodiment according to the invention work will not be explained again here. In addition the front pressing device 4′ and the back pressing device 5′ with their respective force transducer 6′ and pneumatic drive 7′ are shown only diagrammatically.

The other reference numbers on FIG. 3 and FIG. 4 that show elements of the exemplary embodiment according to the invention that deviate from the exemplary embodiment not conforming to the invention do not bear the quote mark. Their function and importance will be explained below.

The essential difference between the exemplary embodiment not conforming to the invention (FIG. 1 and FIG. 2) and the exemplary embodiment according to the invention (FIG. 3 and FIG. 4) is that the three-roll mill depicted here has three rolls 1′, 2′, 3′ which, while aligned parallel to each other, are not all arranged in the same plane. Rather, the rotational axis A1′ of the front roll 1′ and the rotational axis A2′ of the middle roll 2′ are arranged in a first plane E1, while the rotational axis A3′ of the back roll 3′ and the rotational axis A2′ of the middle roll 2′ are arranged in a second plane E2 that forms an angle γ of about 45° relative to the first plane E1. As a result of arranging the three rolls 1′, 2′, 3′ in this way, the product present as a viscous mass with the solid particles (e.g., pigments) distributed therein can be cooled for a longer period of time, and hence more intensively, than in an arrangement in which the rotational axes of the front, middle and back roll lie in a single plane.

FIG. 4 is a top view of the rolls 1′, 2′, 3′ of the second embodiment of the roll mill according to the invention shown on FIG. 3. Here as well, the front roll or feeder roll 1′ and middle roll 2′ both have the same processing length L1′=L2′, while the back roll or transfer roll 3′ has a distinctly shorter processing length L3′<L2′. The back roll 3′ is also axially arranged relative to the middle roll 2′ in such a way that the ends of the processing length L2′ of the middle roll 2′ extend axially over the ends of the processing length L3′ of the back wall 3′ on both sides. As already explained, this ensures that no unabraded or only inadequately abraded product gets from the middle roll 2′ to the back roll 3′ during operation of the three-roll mill, thereby improving product quality.

The path traversed by the product as it passes through the roll mill according to the second exemplary embodiment is increased by the two additional circular arc lengths at the surfaces S2′ and S3′ of the roll 2′ and 3′ with radius R that arise between plane E1 and plane E2 as the result of angle γ, i.e., an additional path relative to the first exemplary embodiment (FIG. 1) by 2×γ×R.

A transfer funnel or product trough 8 with stacking wedges extending from the introduction region on either side is arranged over the area of the introduction nip between the front roll 1′ and the middle roll 2′. As the result of the stacking wedges provided in addition to the conventional wedge gaskets, this product trough increases tightness, thereby ensuring a lower lateral product loss.

A stripper 9 with a stripping knife is used for removing the product from the back roll 3′. The stripper 9 is equipped with an automatic knife adjustment, which is actuated from an SPS controller.

In both the first and second exemplary embodiment, the roll surfaces or roll processing surfaces S1, S2, S3 or S′, S2′, S3′ can be made out of ceramic material. The stripper 9 shown on FIG. 3 can also consist of ceramic material or polymer material. These or other metal-free materials for the roll processing surfaces and the stripper knife are of particular interest for processing pastes in the electronics industry.

The ceramic rolls are rounded at the end of the roll processing length.

The pneumatic drive 7 operates at pressures of up to 4 bar, for example, which are brought to bear via the force transducers 6 on the required line pressures in the roll nips. The force transducer 6 make sit possible to increase the pressing force exerted on the rolls by the roll pressing devices 4, 5 by a factor of about 10 to about 80. Accordingly, the reduction in the stroke prescribed by the pneumatic drive 7 via the force transducer increase the nip setting accuracy by the same factor.

The rolls have a diameter of 300 mm, and the back roll 3, 3′ is about 4 mm to 5 mm shorter than the middle roll 2, 2′. As a result, the stripper 9 only strips abraded product from the back roll 3′.

Although the present invention has been described in relation to particular embodiments thereof, many other variations and modifications and other uses will become apparent to those skilled in the art. It is preferred, therefore, that the present invention be limited but by the specific disclosure herein, but only by the appended claims.

1. A roll mill for comminuting and homogenizing viscous masses, comprising:
a front roll, a back roll and a middle roll pivoted around their longitudinal axes, wherein a rotational axis of the middle roll is fixed in place, and a rotational axis of at least one other roll is movable; and
at least one pressing device for pressing at least one of the front and back rolls against the middle roll, wherein a first plane defined by the rotational axis of the front roll and by the rotational axis of the middle roll, and a second plane defined by the rotational axis of the middle roll and the rotational axis of the back roll, are inclined relative to each other by an angle of between 10° and 90, the rolls having surfaces made out of a metal-free ceramic material.

2. The roll mill according to claim 1, wherein in that the first plane runs horizontally, while the second plane runs upwardly inclined.

3. The roll mill according to claim 1, wherein the rolls have a ceramic cylinder fit onto a hollow metal cylinder.

4. The roll mill according to claim 1, wherein the rolls are internally cooled.

5. The roll mill according to claim 1, wherein the pressing device has a controller for setting a nip.

6. The roll mill according to claim 1, wherein the pressing device is a mechanical-pneumatic pressing device.

7. The roll mill according to claim 1, wherein the back roll used for product removal has a shorter axial processing length than a processing length of the middle roll, and is axially situated relative to the middle roll so that ends of the processing length of the middle roll extend over ends of the processing length of the back roll on both sides.

8. The roll mill according to claim 7, wherein the back roll is 2 mm to 10 mm shorter than the middle roll.

9. The roll mill according to claim 8, wherein the back roll is 3 mm to 6 mm shorter than the middle roll.

10. The roll mill according claim 1, wherein the angle measures 30° to 60.

11. The roll mill according to claim 10, wherein the angle measures 45°.
